(19) United States
(12) Patent Application Publication
(10) Pub. No.: US 2013/0096869 A1
(43) Pub. Date: Apr. 18, 2013

(54) INFORMATION PROCESSING APPARATUS, INFORMATION PROCESSING METHOD, AND COMPUTER READABLE MEDIUM STORING PROGRAM

(71) Applicants: Hideto YUZAWA, Kanagawa (JP); Toshiroh SHIMADA, Kanagawa (JP); Tomoyuki SHOYA, Kanagawa (JP)

(72) Inventors: Hideto YUZAWA, Kanagawa (JP); Toshiroh SHIMADA, Kanagawa (JP); Tomoyuki SHOYA, Kanagawa (JP)

(73) Assignee: FUJI XEROX CO., LTD., Tokyo (JP)

(21) Appl. No.: 13/442,329

(22) Filed: Apr. 9, 2012

(30) Foreign Application Priority Data
Oct. 12, 2011 (JP) 2011-224551

(51) Int. Cl. G06F 15/00

(52) U.S. Cl. 702/150

(57) ABSTRACT

An information processing apparatus includes an analysis unit, a starting point determination unit, and a coordinate conversion unit. The analysis unit analyzes an action history of a first subject, in accordance with action information obtained by detecting an action of the first subject. The starting point determination unit determines a position of a starting point of an action of the first subject, in accordance with the action history analyzed by the analysis unit. The position of the starting point is represented as a relative coordinate position. When a second subject different from the first subject has an absolute coordinate position, the coordinate conversion unit converts the relative coordinate position representing the starting point of the action of the first subject into an absolute coordinate position, in accordance with the absolute coordinate position of the second subject.

### CROSS-REFERENCE TO RELATED APPLICATIONS

This application is based on and claims priority under 35 USC 119 from Japanese Patent Application No. 2011-224551 filed Oct. 12, 2011.

### BACKGROUND

(i) Technical Field

The present invention relates to an information processing apparatus, an information processing method, and a computer readable medium storing a program.

(ii) Related Art

Techniques for detecting actions of a subject are available.

### SUMMARY

According to an aspect of the invention, there is provided an information processing apparatus including an analysis unit, a starting point determination unit, and a coordinate conversion unit. The analysis unit analyzes an action history of a first subject, in accordance with action information obtained by detecting an action of the first subject. The starting point determination unit determines a position of a starting point of an action of the first subject, in accordance with the action history analyzed by the analysis unit. The position of the starting point is represented as a relative coordinate position. When a second subject different from the first subject has an absolute coordinate position, the coordinate conversion unit converts the relative coordinate position representing the starting point of the action of the first subject into an absolute coordinate position, in accordance with the absolute coordinate position of the second subject.

### BRIEF DESCRIPTION OF THE DRAWINGS

An exemplary embodiment of the present invention will be described in detail based on the following figures, wherein:

FIG. 1 is a conceptual module block diagram of an example configuration of an information processing apparatus according to an exemplary embodiment;

FIG. 2 is a flowchart illustrating an example of a process according to the exemplary embodiment;

FIG. 3 illustrates an example of a process according to the exemplary embodiment;

FIG. 4 illustrates an example data structure of a sensor/user correspondence table;

FIGS. 5A to 5D illustrate examples of measurement data to be processed;

FIG. 6 illustrates an example of a process according to the exemplary embodiment;

FIG. 7 illustrates an example of the count of the number of footsteps in the measurement data;

FIGS. 8A and 8B illustrate an example of a direction of measurement data;

FIG. 9 illustrates an example of a process according to the exemplary embodiment;

FIG. 10 is a flowchart illustrating an example of a process according to the exemplary embodiment;

FIG. 11 illustrates an example of a process according to the exemplary embodiment;

FIG. 12 illustrates an example of a process according to the exemplary embodiment;

FIG. 13 illustrates an example data structure of a relationship table; and

FIG. 14 is a block diagram illustrating an example hardware configuration of a computer for implementing the exemplary embodiment.

### DETAILED DESCRIPTION

An exemplary embodiment of the present invention will be described hereinafter with reference to the drawings.

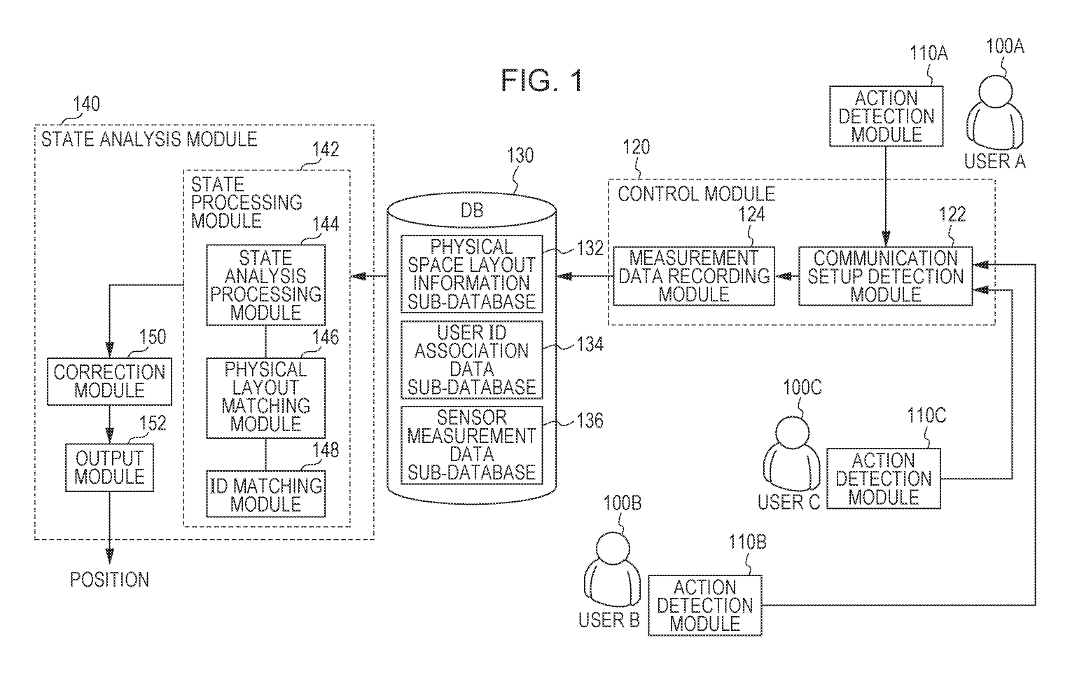

FIG. 1 is a conceptual module configuration diagram of an example configuration of an information processing apparatus according to the exemplary embodiment.

The term “module” generally refers to a logically separable part of software (computer program), hardware, or the like. Therefore, the term “module” as used in this exemplary embodiment refers to not only a module in a computer program but also a module in a hardware configuration. Thus, this exemplary embodiment will be described in the context of a computer program for providing functions of modules (a program for causing a computer to execute individual procedures, a program for causing a computer to function as individual units, and a program for causing a computer to realize individual functions), a system, and a method. While “storing”, “being stored”, and equivalent terms are used for convenience of description, such terms indicate, when the exemplary embodiment relates to a computer program, storing of the computer program in a storage device or performing of control to store the computer program in a storage device. Furthermore, modules and functions may have a one-to-one correspondence. In terms of implementation, one module may be composed of one program, plural modules may be composed of one program, or, conversely, one module may be composed of plural programs. Additionally, plural modules may be executed by a single computer, or a single module may be executed by plural computers in a distributed or parallel environment. One module may include another module. Further, hereinafter, the terms “connection” and “setting up of communication” or “communication setup” include physical connection and logical connection (such as exchanging data, issuing an instruction, and cross-reference between data items). The term “predetermined” means “determined before” the performance of a desired process, and may include “determined before” the start of a process according to the exemplary embodiment, and “determined before” the performance of a desired process even after the start of a process according to the exemplary embodiment, in accordance with the current state and condition or in accordance with the previous state and condition. The phrase “if A, then B” or words of similar meaning means that “it is determined whether or not A, and B if it is determined that A” unless the determination of whether or not A is required.

Furthermore, the term “system” or “apparatus” includes a configuration in which plural computers, hardware components, devices, or other suitable elements are connected to one another via a communication medium such as a network (including a one-to-one communication setup), and what is implemented by a single computer, hardware component, device, or suitable element. The terms “apparatus”, “device”, and “system” are used synonymously. It is to be understood that the term “system” does not include what is merely a social “mechanism” (social system) based on artificial rules.

Moreover, desired information is read from a storage device for each process performed by an individual module or, if plural processes are performed within a module, for each of the plural processes, and is processed. The process result is written in the storage device. Therefore, reading of information from the storage device before processing the information and writing of information to the storage device after processing the information may not necessarily be described herein. The term “storage device”, as used herein, may include a hard disk, a random access memory (RAM), an external storage medium, a storage device using a communication line, and a register in a central processing unit (CPU).

The information processing apparatus according to this exemplary embodiment is configured to generate a map using action information about actions measured by an action detection module that a subject (hereinafter also referred to as a “user”) carries. As illustrated in the example in FIG. 1, the information processing apparatus includes action detection modules 110A to 110C that users 100A to 100C carries, respectively, a control module 120, a database (DB) 130, and a state analysis module 140.

The user 100A (user A) carries the action detection module 110A, the user 100B (user B) carries the action detection module 110B, and the user 100C (user C) carries the action detection module 110C. The users 100A to 100C (hereinafter collectively referred to as “users 100” or individually referred to as a “user 100”) are subjects according to this exemplary embodiment. In this exemplary embodiment, a map of the inside of a room (or office) where the users 100 work is generated. The map includes at least the seating positions of the users 100 and aisles.

In general, restricted or stereotyped actions are seen in the office, such as sitting, standing, walking, writing in a notebook, typing on a keyboard, and writing on a whiteboard. When a subject performs an action such as sitting, features are extracted from action information detected by the corresponding action detection module 110, and are stored in a dictionary. The dictionary storing the features of actions is created in advance. Thus, an action performed by a subject may be determined on the basis of action information detected by the corresponding action detection module 110, using pattern matching with the features in the dictionary.

The action detection modules 110A, 110B, and 110C (hereinafter collectively referred to as “action detection modules 110” or individually referred to as an “action detection module 110”) are connected to a communication setup detection module 122. An action detection module 110 is carried by a user 100, and may be a sensor that detects the action of the user 100 or a communication device that communicates with an action detection module 110 that another user 100 carries. The action detection module 110 passes action information (also referred to as “measurement data”) that is information detected by the action detection module 110 to the communication setup detection module 122. The action information is generally passed to the communication setup detection module 122 via wireless communication. Alternatively, the action information may be passed to the communication setup detection module 122 via wired communication, or the action information may be stored in a storage device in the action detection module 110 and read from the storage device by using the communication setup detection module 122.

The action detection module 110 may be incorporated in a mobile phone or the like, formed in a card or the like, or embedded in a wristband or the like so as to be fixedly attached to the arm of the user 100 so long as the action detection module 110 has functions of a communication device and functions of a sensor that detects the action of the user 100.

Examples of the action information include measurement data obtained by the sensor that the subject carries, and communication information obtained as a result of communication performed by the communication device that the subject carries.

Examples of the sensor include an acceleration sensor (for measuring the acceleration and the like of the subject who carries the acceleration sensor), a compass (for measuring the orientation and the like of the subject who carries the compass), and a gyroscope (for detecting the angle, angular velocity, and the like of the subject who carries the gyroscope). In the following description of this exemplary embodiment, measurement data obtained by the above three sensors is used by way of example. Examples of the measurement data include information capable of uniquely identifying the action detection module 110 according to this exemplary embodiment, such as a sensor ID, acceleration, direction, angle, and angular velocity, and the measurement date and time (the combination of one or more of year, month, day, hour, minute, second, millisecond, etc.). The information about a position included in the action information generally includes information about a relative coordinate position but does not include information about an absolute coordinate position, or may include information about an absolute coordinate position detected with low accuracy. For example, in an office, or a room, positions may be measured with low global positioning system (GPS) accuracy or the like or may be unmeasurable.

The communication device will be described in the context of a near field communication device (such as a Bluetooth (registered trademark) communication device). When a given communication device communicates with another communication device, a communication device ID (A) capable of uniquely identifying the given communication device according to this exemplary embodiment, a communication device ID (B) capable of uniquely identifying the other communication device according to this exemplary embodiment, the communication date and time, etc. may be included in the communication information.

The control module 120 includes the communication setup detection module 122 and a measurement data recording module 124. The control module 120 receives action information from the action detection module 110, and stores the received action information in the DB 130.

The communication setup detection module 122 is connected to the action detection modules 110A, 110B, and 110C, and the measurement data recording module 124. The communication setup detection module 122 determines whether or not it is possible to communicate with an action detection module 110. If it is determined that it is possible to communicate with an action detection module 110, the communication setup detection module 122 receives action information from the action detection module 110, and passes the action information to the measurement data recording module 124.

The measurement data recording module 124 is connected to the communication setup detection module 122 and the DB 130. The measurement data recording module 124 receives measurement data from the communication setup detection module 122, and stores the measurement data in a sensor measurement data sub-database 136 included in the DB 130. A user ID association data sub-database 134, which will be described below, may be searched for action information, and the action information may be stored in the sensor measurement data sub-database 136 in association with a user ID.

The DB 130 is connected to the measurement data recording module 124 and a state processing module 142. The DB 130 stores a physical space layout information sub-database 132, the user ID association data sub-database 134, and the sensor measurement data sub-database 136.

The physical space layout information sub-database 132 stores information about a device that detects an action detection module 110 or the like that a user 100 carries. Example of information about a device include a device ID capable of uniquely identifying the device, which is a fixed device, according to this exemplary embodiment, and information about the absolute coordinate position of a place where the device is located. The physical space layout information sub-database 132 stores a table or the like in which the device ID and the absolute coordinate position are stored in association with each other. Examples of the device include a flapper gate (used for entry/exit management and configured to detect an element capable of specifying a user, for example, but not limited to, an action detection module 110), and a copying machine (which is available for a user after the copying machine has read information about the action detection module 110 or the like that the user carries). The situation where the above device has detected an action detection module 110 or the like implies that the user who carries the action detection module 110 or the like is in the location of the device at the detection time. The absolute coordinates may be coordinates specified by latitude and longitude, and it is sufficient that a position specified by the device is fixed in a map generated according to this exemplary embodiment.

The physical space layout information sub-database 132 further stores a table or the like in which a device ID capable of uniquely identifying a device having an absolute coordinate position and a user ID detected by the device having the same device ID are stored in association with each other.

The user ID association data sub-database 134 stores a user ID that is information capable of uniquely identifying a user 100 according to this exemplary embodiment. For example, a sensor/user correspondence table 400 illustrated in an example in FIG. 4 may be stored. The sensor/user correspondence table 400 contains a “Sensor ID” column 410 and a “User ID” column 420. The “Sensor ID” column 410 stores a sensor ID that is information capable of uniquely indentifying an action detection module 110 according to this exemplary embodiment. The “User ID” column 420 stores a user ID of the user 100 who carries the action detection module 110 associated with the sensor ID. The use of the sensor/user correspondence table 400 allows measurement data and a user ID to be associated with each other.

The user ID association data sub-database 134 may also store, in association with a user ID, a communication device ID that is information capable of uniquely identifying the communication device in the corresponding action detection module 110 according to this exemplary embodiment. The use of the user ID association data sub-database 134 allows a communication device and a user ID to be associated with each other.

The user ID association data sub-database 134 may also store the stride length of a user 100 in association with the corresponding user ID. The use of the user ID association data sub-database 134 and the number of footsteps made by a user allows a moving distance of the user to be calculated.

The user ID association data sub-database 134 may also store a starting point position determined by a state analysis processing module 144, which will be described below, in association with the corresponding user ID.

The sensor measurement data sub-database 136 stores the action information passed from the measurement data recording module 124. As described above, the action information includes a sensor ID, the measurement date and time, and the data measured by the sensor identified by the sensor ID. The action information may also be stored in association with a user ID. By analyzing the action information in the sensor measurement data sub-database 136, it may be possible to determine what action was performed, by who, and when.

The state analysis module 140 includes the state processing module 142, a correction module 150, and an output module 152.

The state processing module 142 is connected to the DB 130 and the correction module 150. The state processing module 142 includes the state analysis processing module 144, a physical layout matching module 146, and an ID matching module 148.

The state analysis processing module 144 is connected to the physical layout matching module 146. The state analysis processing module 144 analyzes the state of a user on the basis of the action information about the user. The state of a user includes at least the position of the user. The state analysis processing module 144 determines, as a relative coordinate position, a position that is the position of the action starting point of the user on the basis of the analyzed state. The action starting point of a subject may be a place where the subject stays longer than in any other place, for example, the seating position of the subject (also generally called the “seat”). The state analysis processing module 144 stores the position of the starting point in the user ID association data sub-database 134 in the DB 130 in association with the corresponding user ID.

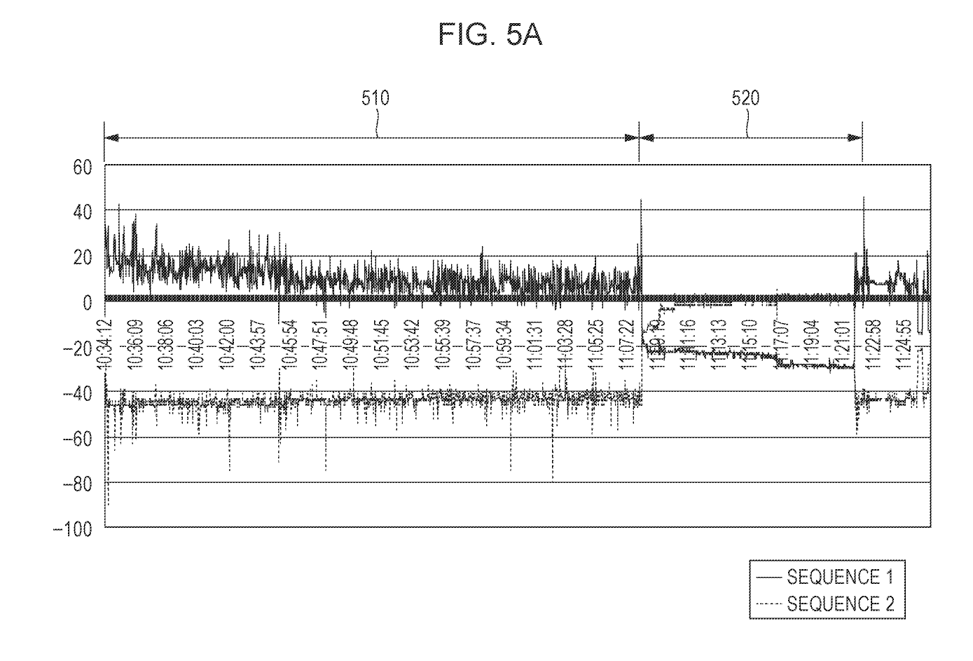

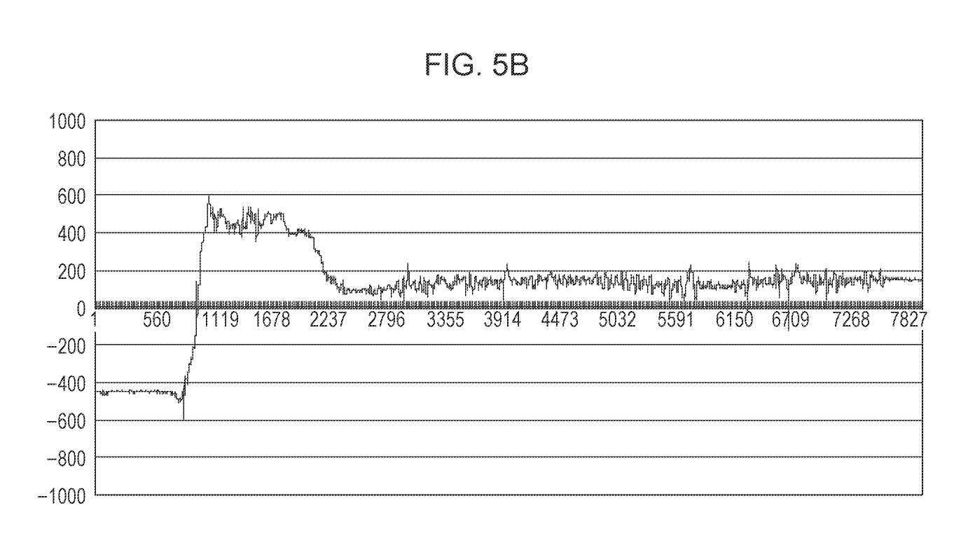

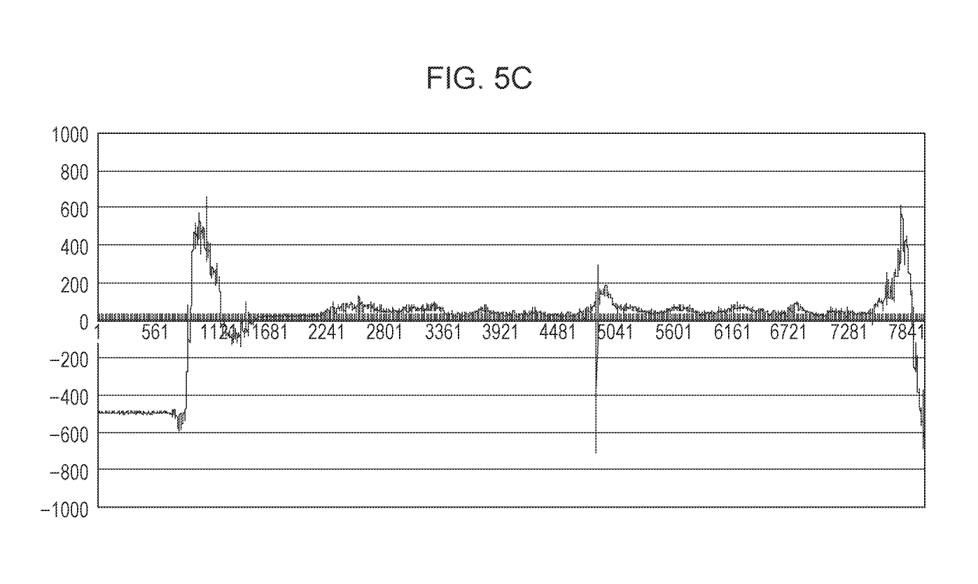

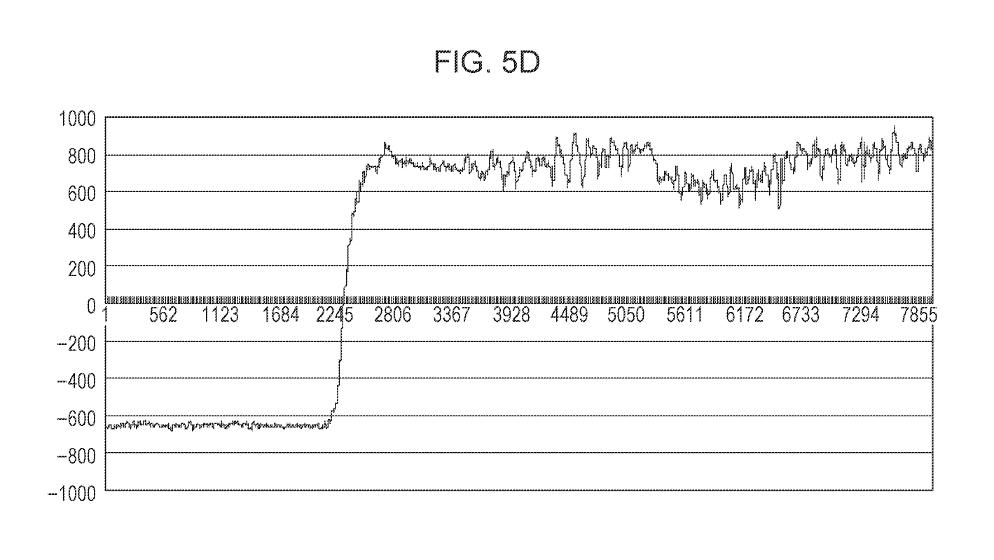

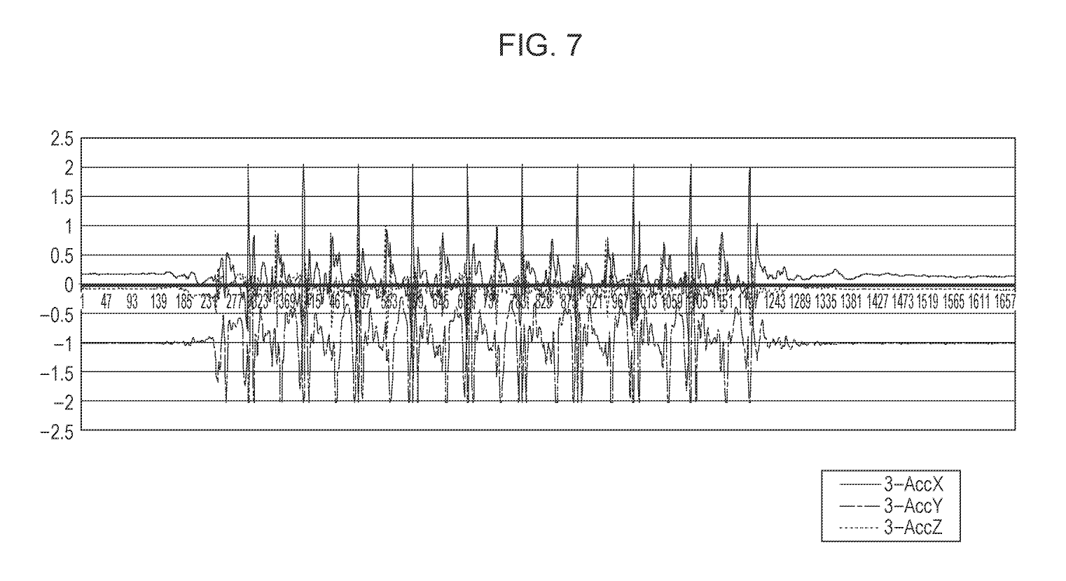

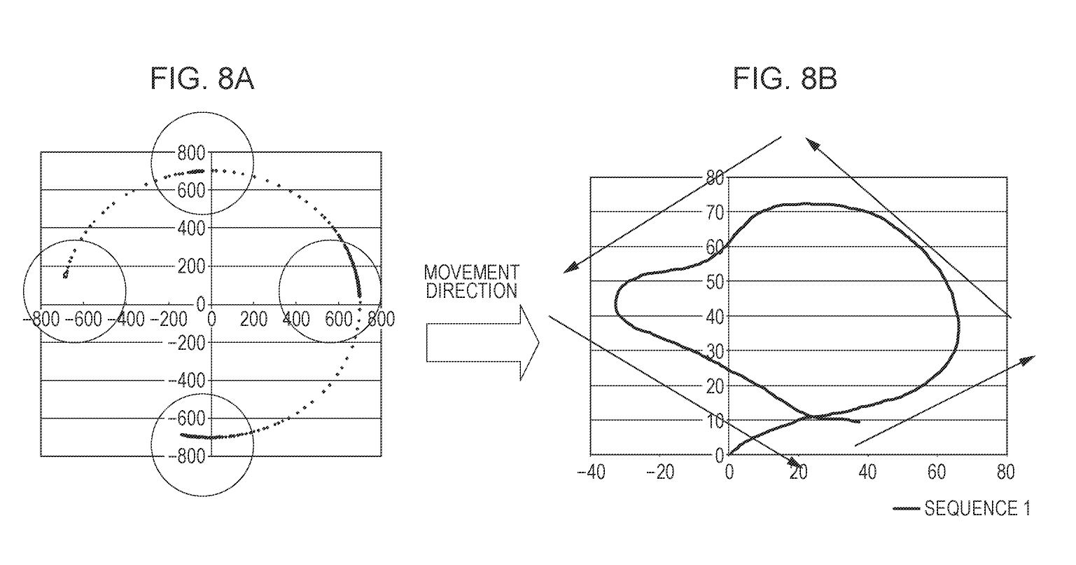

Examples of the state of a user to be analyzed include sitting, standing, walking, writing in a notebook, typing on a keyboard, and writing on a whiteboard. Results of analysis include date and time information, the direction of the user at the date and time specified by the date and time information, the number of footsteps made when the user is walking, and a walking distance or the like calculated using the number of footsteps and the stride length of the user, which is stored in, as described above, the user ID association data sub-database 134. FIGS. 5A to 5D illustrate an example of measurement data to be processed (measurement data obtained by the acceleration sensor). As described above, the state analysis is performed by extracting features from the measurement data and performing pattern matching with states in a dictionary. In the example illustrated in FIG. 5A, the measurement data may be separated into a standing period 510 and a sitting period 520 using, for example, frequency analysis. In the example illustrated in FIG. 5B, the state of writing in a notebook is obtained as a result of analysis. In the example illustrated in FIG. 5C, the state of typing on a keyboard is obtained as a result of analysis. In the example illustrated in FIG. 5D, the state of writing on a whiteboard is obtained as a result of analysis. Further, as illustrated in an example in FIG. 7, peaks in the measurement data obtained by the acceleration sensor are counted to determine the number of footsteps made by the user. The state analysis processing module 144 may extract the user ID of the user 100 who carries the action detection module 110 that has detected the measurement data, by using the sensor/user correspondence table 400, extract the stride length of the user 100 having the user ID from the user ID association data sub-database 134, and calculate a moving distance by multiplying the number of footsteps by the stride length. Furthermore, a movement path (trajectory) illustrated in an example in FIG. 8B may be calculated on the basis of the moving distance and the measurement data obtained by the compass illustrated in an example in FIG. 8A. The movement path may be an aisle in the map.

A technique for determining whether or not a given position represents an action starting point will be described. The state analysis processing module 144 determines that the position of a user who is sitting at a desk and is working (such as writing in a notebook or typing on a keyboard) for a predetermined period of time or longer represents an action starting point. The determination may be based on the condition that the user is sitting for a predetermined period of time or longer or on the conditions that the user is sitting at a desk and is working for a predetermined period of time or longer. The action starting point position is presented using the relative coordinates, and may be, for example, the coordinate starting point (0, 0) of the user 100.

The action information further includes communication information indicating that the communication devices in the action detection modules 110 owned by subjects have communicated with each other. The state analysis processing module 144 may extract a combination of subjects who have communicated with each other, in accordance with the communication information in the action information. That is, the state analysis processing module 144 may specify the communication device IDs (A) and (B) of the communication devices that have communicated with each other, and extract the user IDs of the users who carry the communication devices having the communication device IDs (A) and (B), by using the user ID association data sub-database 134. The state analysis processing module 144 then determines that the user having the user ID associated with the communication device ID (B) extracted at the communication device having the communication device ID (A) and the user having the user ID associated with the communication device ID (A) extracted at the communication device having the communication device ID (B) are getting together. Specifically, the state analysis processing module 144 determines that one of the users having the above user IDs is getting together with the other user when the user ID of the other user is extracted. The extraction of a combination of subjects may be based on the condition that communication between the subjects lasts for a predetermined period of time or longer.

The action information further includes direction information and position information indicating the direction and position of the subject, respectively. The state analysis processing module 144 may extract a combination of subjects that have communicated with each other, in accordance with the direction information and position information in the action information. That is, the state analysis processing module 144 may specify the sensor IDs of plural action detection modules 110 that have detected the information and position information, and extract the user IDs of the users who carry the action detection modules 110 having the sensor IDs, by using the user ID association data sub-database 134. The state analysis processing module 144 then determines that the users having the extracted user IDs are in communication with each other. Specifically, when user IDs are extracted, the state analysis processing module 144 determines that users having the extracted user IDs are in communication with each other. The extraction of a combination of subjects who are in communication with each other may be based on the condition that communication between the subjects has been successfully achieved for a predetermined period of time or longer.

The state analysis processing module 144 may also extract a combination of subjects who are getting together, on the basis of the direction information and position information in the action information without using information about communication between communication devices. That is, the state analysis processing module 144 may specify the sensor IDs of plural action detection modules 110 that have detected the direction information and position information, and extract the user IDs of the users who carry the action detection modules 110 having the sensor IDs, by using the user ID association data sub-database 134. The state analysis processing module 144 then determines that the users having the extracted user IDs are getting together. Specifically, when user IDs are extracted, the state analysis processing module 144 determines that users having the extracted user IDs are getting together. The extraction of a combination of subjects may be based on the condition that the subjects are getting together for a predetermined period of time or longer.

The physical layout matching module 146 is connected to the state analysis processing module 144 and the ID matching module 148. The physical layout matching module 146 has a function of converting the relative coordinate position of the action starting point determined by the state analysis processing module 144 into an absolute coordinate position. The physical layout matching module 146 may execute the function of performing conversion from a relative coordinate position to an absolute coordinate position, in response to an action of a given user or any other user, when a device having an absolute coordinate position detects the given user or any other user.

For example, if a target user 100 has passed a flapper gate, the relative coordinate position of the starting point of the user 100 is converted into an absolute coordinate position on the basis of the moving distance from when the user 100 passed the flapper gate, the direction of the flapper gate when viewed from the user 100, and the absolute coordinate position of the flapper gate.

The physical layout matching module 146 may also change the relative coordinate position of the action starting point of a target user into an absolute coordinate position, on the basis of a combination of users extracted by the state analysis processing module 144, using the absolute coordinate position of the action starting point of another user. For example, if another user has passed the flapper gate, the position of the flapper gate may be used as the absolute coordinate position of the action starting point of the other user. The absolute coordinate position of the action starting point of the target user may be calculated from the absolute coordinate position of the action starting point of the other user and the position of the place where the target user and the other user get together.

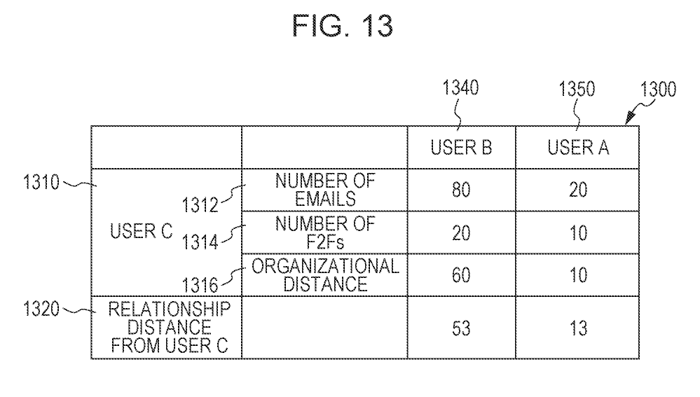

The physical layout matching module 146 may extract a combination of users on the basis of relationship information indicating a relationship between users. The relationship information will be described below using a relationship table 1300 illustrated in an example in FIG. 13.

The physical layout matching module 146 may also generate a map in which the position of a desk is the position of an action starting point of a user and an aisle is a path along which the user has moved.

The ID matching module 148 is connected to the physical layout matching module 146. The ID matching module 148 extracts information corresponding to identification information identifying a target user from the user ID association data sub-database 134. The ID matching module 148 performs an extraction process in response to a request from the state analysis processing module 144 and the physical layout matching module 146, and passes a result to the requesting state analysis processing module 144 and the physical layout matching module 146. Examples of the information to be extracted include a user ID associated with a sensor ID, a user ID associated with a communication device ID, and a stride length of a user having a user ID.

The correction module 150 is connected to the state processing module 142 and the output module 152. The correction module 150 corrects the position of the starting point of each user, a map, or the like, which is generated by the physical layout matching module 146. In an office where a large number of electronic devices such as personal computers are installed, the accuracy of a sensor such as a compass may be reduced. Therefore, for example, the correction module 150 generates plural positions of the action starting points of each user, plural maps, or the like, using action information about plural users and action information about actions of each user within multiple days, and corrects the generated results using their average value, mode value, central value, or the like.

The output module 152 is connected to the correction module 150. The output module 152 outputs the position of the starting point of the individual user, the map, or the like, which has been corrected by the correction module 150. For example, the output module 152 may perform operations such as printing a map using a printer, displaying a map on a display device such as a display, passing a map to an information processing apparatus such as a map database, and storing a map in a storage medium such as a memory card.

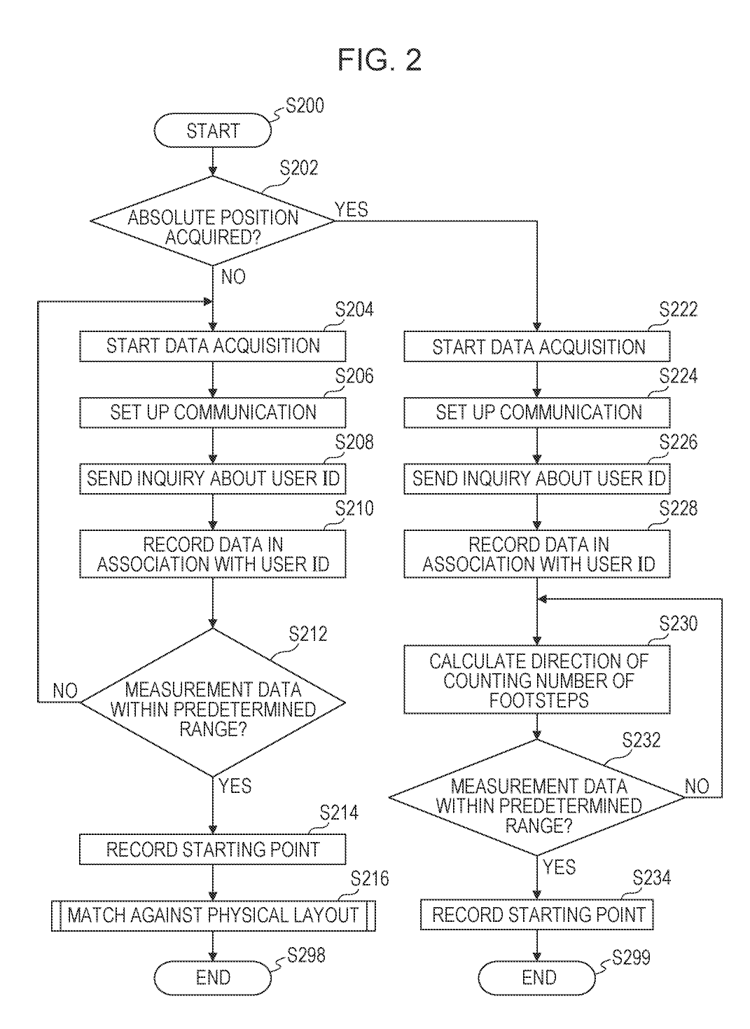

FIG. 2 is a flowchart illustrating an example of a process according to this exemplary embodiment.

In step S202, the state analysis processing module 144 determines whether or not the absolute coordinate position (hereinafter also referred to as the “absolute position”) of a target user has been acquired. If the absolute position of the target user has been acquired, the process proceeds to step S222, and the process proceeds to step S204 otherwise. For example, if the target user has passed the flapper gate described above, the process proceeds to step S222. The state analysis processing module 144 searches the physical space layout information sub-database 132 to determine whether or not the absolute position of the target user has been acquired.

In step S204, the action detection module 110 starts data acquisition. For example, each sensor in the action detection module 110 detects the action of the user.

In step S206, the communication setup detection module 122 sets up communication with the action detection module 110.

In step S208, the measurement data recording module 124 sends an inquiry about the user ID. That is, the user ID association data sub-database 134 is searched for the user ID using the sensor ID, and the user ID is extracted.

In step S210, the measurement data recording module 124 records measurement data in the sensor measurement data sub-database 136 in association with the user ID.

In step S212, the state analysis processing module 144 determines whether or not the measurement data is within a predetermined range. If the measurement data is within the range, the process proceeds to step S214, and the process is performed from step S204 otherwise.

In step S214, the state analysis processing module 144 records the action starting point of the target user. Here, the position of the action starting point is represented using the relative coordinates.

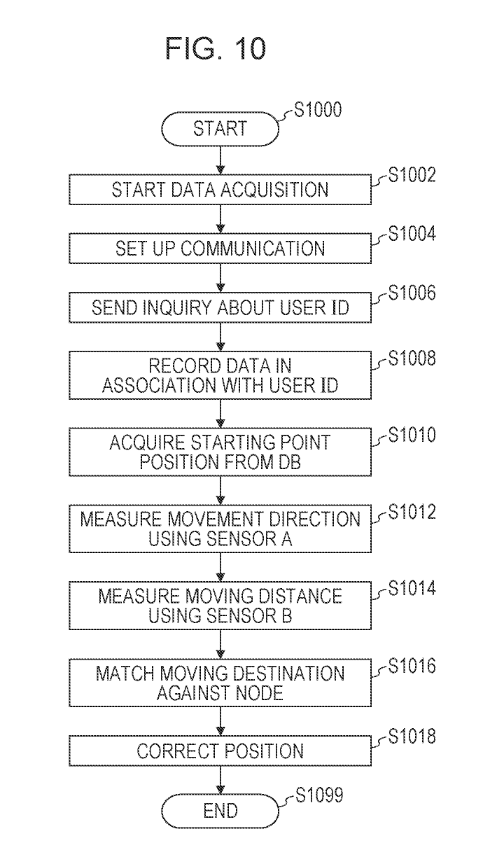

In step S216, the physical layout matching module 146 performs matching against a physical layout. This matching process will be described below with reference to FIG. 10 and other figures.

In step S222, the action detection module 110 starts data acquisition. For example, each sensor in the action detection module 110 detects the action of the user.

In step S224, the communication setup detection module 122 sets up communication with the action detection module 110.

In step S226, the measurement data recording module 124 sends an inquiry about the user ID. That is, the user ID association data sub-database 134 is searched for the user ID using the sensor ID, and the user ID is extracted.

In step S228, the measurement data recording module 124 records measurement data in the sensor measurement data sub-database 136 in association with the user ID.

In step S230, the state analysis processing module 144 counts the number of footsteps made by the user, and calculates the direction. That is, the moving distance from and the direction with respect to the absolute position determined in step S202 are calculated.

In step S232, the state analysis processing module 144 determines whether or not the measurement data is within a predetermined range. If the measurement data is within the range, the process proceeds to step S234, and the process is performed from step S230 otherwise.

In step S234, the state analysis processing module 144 records the action starting point of the target user. Here, the position of the action starting point is represented using the absolute coordinates.

Through the above process, a user having an action starting point represented in the absolute coordinates and a user having an action starting point represented in the relative coordinates may be concurrently present.

The predetermined range used in the determination in steps S212 and S232 may be, as described below, a range obtained when the user is sitting at a desk and is working for a predetermined period of time or longer.

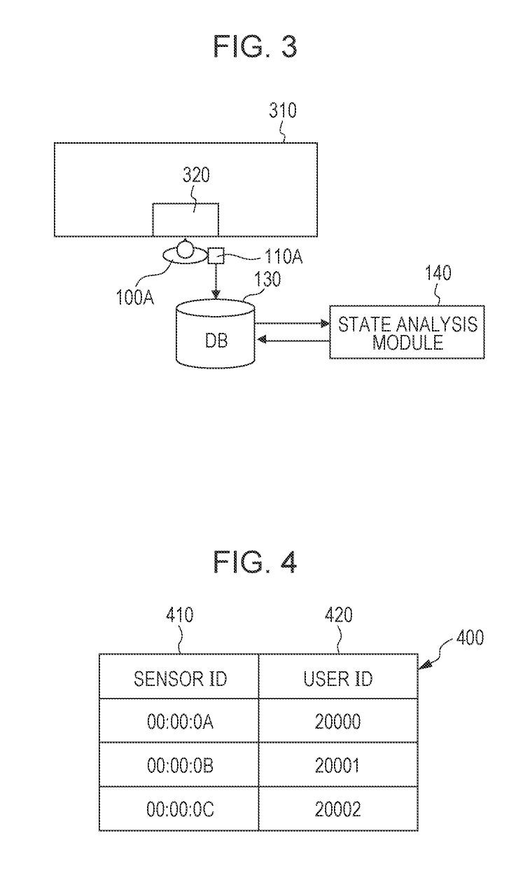

FIG. 3 illustrates an example of a process according to this exemplary embodiment.

In the example illustrated in FIG. 3, the user 100A having the action detection module 110A is sitting at a desk 320 in a block 310 in an office, and the block 310 includes plural desks. While, in the example illustrated in FIG. 1, action information is sent from the action detection module 110A and is stored in the DB 130 via the control module 120, the control module 120 is not illustrated in FIG. 3.

The action detection module 110A detects the action of the user 100A, and starts the acquisition of action information. Then, the action detection module 110A matches the sensor IDs associated with the action detection modules 110 that are in communication with the DB 130 (control module 120) against user IDs, and specifies the user A (the user 100A). For example, a user ID may be extracted from the sensor ID of the action detection module 110A by using the sensor/user correspondence table 400, illustrated in the example in FIG. 4, in the user ID association data sub-database 134.

Then, the state analysis processing module 144 in the state analysis module 140 determines, using the measurement data obtained by the acceleration sensor, whether or not the target user is sitting. As described above, in the example illustrated in FIG. 5A, the state analysis processing module 144 separates the measurement data into the standing period 510 and the sitting period 520.

Then, the state analysis processing module 144 performs frequency analysis on the measurement data obtained by the acceleration sensor, and determines whether the user is sitting at a desk and is working or is in a meeting. As described above, in the examples illustrated in FIGS. 5B and 5C, it is determined that the user is sitting at a desk and is working. In the example illustrated in FIG. 5D, it is determined that the user is in a meeting.

If the user is sitting at a desk for a predetermined period of time or longer and is working, the state analysis processing module 144 determines that the user is working in the office (or room), and sets the desk as the starting point (the seat).

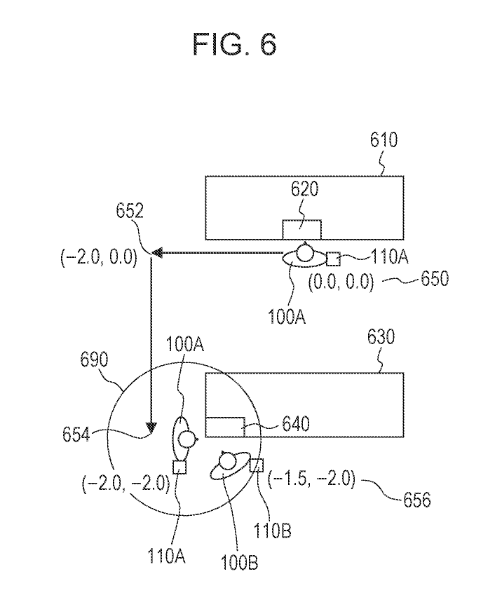

FIG. 6 illustrates an example of a process according to this exemplary embodiment. In the illustrated example, a location (“node”) where users may stop is registered.

The seat (desk 620) of the user A (user 100A) and the seat (desk 640) of the user B (user 100B) are registered as action starting points through the process described above. That is, the action starting point of the user A (100A) is at a position 650, and the action starting point of the user B (100B) is at a position 656.

If the user A (100A) has moved to the desk 640 of the user B (100B), the moving destination (for example, the desk 640) of the user A (100A) may be determined by counting the number of footsteps made by the user A (100A) using acceleration data (see an example illustrated in FIG. 7) and by calculating the movement direction of the user A (100A) using the compass (see an example illustrated in FIG. 8).

In the office, however, the accuracy of a compass serving as a sensor may be reduced, a change in stride length between a wide corridor and a space between chairs may occur, and other undesirable or unexpected results may occur. For example, in the example illustrated in FIG. 6, the user A (100A) may be determined by mistake to be at a position 654 although the user A (100A) is actually at a position (−2.0, −2.0). In the example illustrated in FIG. 6, the observed position 654 is located at an upper left position with respect to the position (−2.0, −2.0).

Therefore, when the user A (100A) is located near the desk 640 (specifically, when the desk 640 is within a target range 690 centered at the position of the user A (100A)), it is determined that the user A (100A) and the user B (100B) are “getting together (and talking)” from the orientation of the user A (100A) (the current measurement data obtained by the compass in the action detection module 110A), the orientation of the user B (100B) (the current measurement data obtained by the compass in the action detection module 110B), and the staying time (a period of time during which it is determined that the user A (100A) stops (the user A (100A) is standing with the number of footsteps being 0)). Then, the relative position of the action starting point of each of the user A (100A) and the user B (100B) is specified using an average value, a mode value, a central value, or any other suitable value of a history of comings and goings of each of the user A (100A) and the user B (100B). The determination of the user A (100A) and the user B (100B) being “getting together (and talking)” may be based on the condition that the communication devices in the action detection modules 110A and 110B are communicating with each other.

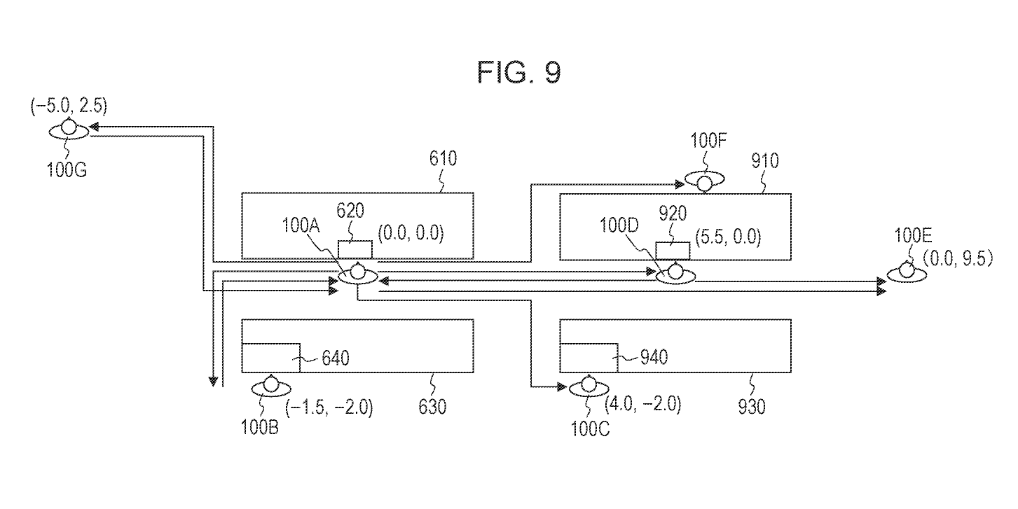

It is to be understood that not only measurement data between two users but also measurement data among three or more users may be analyzed. FIG. 9 illustrates an example of a process according to this exemplary embodiment. A user A (100A) may get together with a user B (100B), a user C (100C), and a user D (100D) at their own seats, and a user G (100G) may get together with a user F (100F) at the seat of the user F (100F) and get together with a user E (100E). Accordingly, measurement data is accumulated, and a map of the entire office is created. That is, the state analysis module 140 determines that a desk is located at the position of the action starting point of each user and that the desk is associated with the seat of the user. The state analysis module 140 further determines that the paths along which the individual users have moved (indicated by arrowed lines in the example illustrated in FIG. 9) are aisles, and creates a map.

In addition, even if the user A (100A) has not moved directly to the seat of the user F (100F), the user G (100G) has moved to the seat of the user F (100F) through the seat of the user A (100A), and therefore the relative coordinate position of the user F (100F) with respect to the action starting point of the user A (100A) may be specified from the action history (measurement data) of the user G (100G). That is, if the user A (100A) has not moved to the action starting point of the user F (100F) from the action starting point of the user A (100A), a path along which another user has moved to the action starting point of the user F (100F) through the action starting point of the user A (100A) may be extracted, and a positional relationship in the relative coordinates between the action starting point of the user A (100A) and the action starting point of the user F (100F) may be determined using the extracted path.

FIG. 10 is a flowchart illustrating an example of a process according to this exemplary embodiment.

In step S1002, the action detection module 110 starts data acquisition. For example, each sensor in the action detection module 110 detects the action of the user.

In step S1004, the communication setup detection module 122 sets up communication with the action detection module 110.

In step S1006, the measurement data recording module 124 sends an inquiry about the user ID. That is, the user ID association data sub-database 134 is searched for the user ID using the sensor ID, and the user ID is extracted.

In step S1008, the measurement data recording module 124 records measurement data in the sensor measurement data sub-database 136 in association with the user ID.

In step S1010, the physical layout matching module 146 acquires the action starting point position corresponding to the user ID of the target user from the user ID association data sub-database 134 in the DB 130.

In step S1012, the physical layout matching module 146 measures a movement direction using the measurement data obtained by the sensor A.

In step S1014, the physical layout matching module 146 measures a moving distance using the measurement data obtained by the sensor B.

In step S1016, the physical layout matching module 146 matches the moving destination against a node. The term “node”, as used herein, refers to, as described above with reference to FIG. 6, a location where users may stop, and may be, as described above, a position determined using an average value, a mode value, a central value, or any other suitable value of a history of comings and goings. The term “matching”, as used herein, refers to extracting of a node within a predetermined distance from the position of the moving destination. The node may be at the position of a device having an absolute coordinate position, such as a flapper gate.

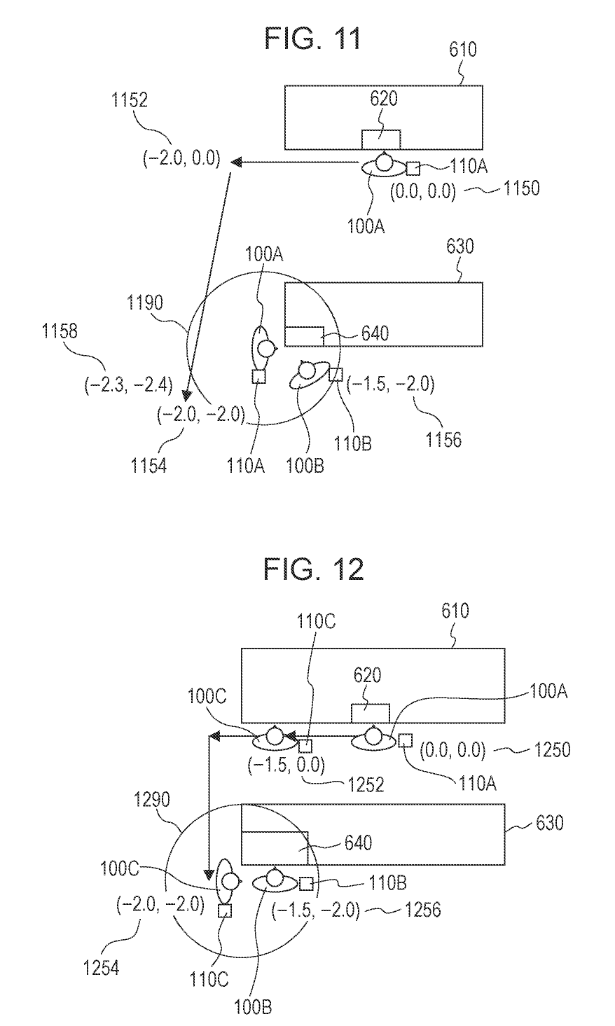

In step S1018, the physical layout matching module 146 corrects the position of the moving destination using the position of the node. For example, the position of the moving destination may be changed to the position of the node, or the position of the moving destination may be shifted to the position of the node in accordance with a predetermined weight. If the node is at the position of a device having an absolute coordinate position, the physical layout matching module 146 changes the relative coordinate position to the absolute coordinate position. That is, the relative coordinate position of the moving destination is changed to the absolute coordinate position of the device. The difference between the previously generated relative coordinate position and the relative coordinate position of the moving destination may be added to or subtracted from the absolute coordinate position of the moving destination. A correction operation described below using examples illustrated in FIGS. 11 and 12 may be used.

FIG. 11 illustrates an example of a process according to this exemplary embodiment. In the illustrated example, a user A (100A) passes through a position 1152 from a position 1150 to see a user B (100B) who carries the action detection module 110B.

If the state analysis module 140 determines that, as in the example illustrated in FIG. 6, the user A (100A) and the user B (100B) are “getting together (and talking)”, the state analysis module 140 determines that the user A (100A) and the user B (100B) are within a normal conversation distance (50 cm to 100 cm), and corrects the position of the user A (100A). It may be assumed that the user A (100A) and the user B (100B) have a history of interacting face to face with each other.

For example, in the example illustrated in FIG. 11, when the moving destination of the user A (100A) is located at a measured position 1158 (−2.3, −2.4) from the measurement data, the action starting point of the user B (100B) is at a position 1156 (−1.5, −2.0). Thus, the correction module 150 may add −0.5 to the value in the x coordinate of the position 1156 (−1.5, −2.0), on the basis of either of or both the current directions of the user A (100A) and the user B (100B), to correct the measured position 1158 to a corrected position 1154. Specifically, since the direction of the user A (100A) is right (90°), only the value in the x coordinate is corrected so as to be away by a conversation distance (a predetermined value of, for example, 50 cm).

FIG. 12 illustrates an example of a process according to this exemplary embodiment.

It is assumed that a user C (100C) has no history of interacting face to face with a user B (100B). In this case, when the user C (100C) stops at a position that is near the action starting point of the user B (100B), the state analysis module 140 performs correction so that the user C (100C) is near the action starting point of the user B (100B), by using the relationship table 1300 indicating relationships among the user B (100B) and the user C (100C). A correction operation similar to that described above with reference to the example in FIG. 11 may be performed.

FIG. 13 illustrates an example data structure of the relationship table 1300. The relationship table 1300 includes a “User C” column 1310 and a “Relationship Distance from User C” column 1320 in the row direction, and a “User B” column 1340 and a “User A” column 1350 in the column direction.

The “User C” column 1310 includes a “Number of Emails” column 1312, a “Number of F2Fs” column 1314, and an “Organizational Distance” column 1316. The “Number of Emails” column 1312 stores the number of emails exchanged between the user C and another user (user B, user A), and the “Number of F2Fs” column 1314 stores the number of times the user C has interacted face to face with another user (user B, user A). The “Organizational Distance” column 1316 stores an organizational distance between the user C and another user (user B, user A) (for example, a value obtained by multiplying the reciprocal of the number of paths between the user C and another user in a tree structure indicating an organizational chart by 100). The “Relationship Distance from User C” column 1320 stores an average value of the values stored in the “Number of Emails” column 1312, the “Number of F2Fs” column 1314, and the Organizational Distance” column 1316. Here, the state analysis module 140 determines that the larger the value, the stronger the relationship. If the value stored in the “Relationship Distance from User C” column 1320 is greater than or equal to a predetermined value and if the positions of the user C (100C) and the user B (100B) are within a predetermined distance, the state analysis module 140 determines that the user C (100C) and the user B (100B) are getting together.

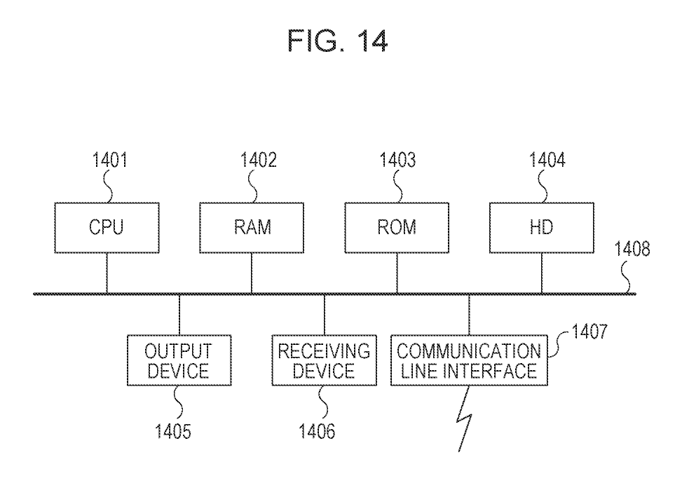

FIG. 14 illustrates an example hardware configuration of a computer that executes a program according to this exemplary embodiment. The computer may be a general computer, specifically, a personal computer, a computer capable of serving as a server, or the like. Specifically, the computer includes a processing unit (arithmetic unit) including a CPU 1401, and a storage device including a RAM 1402, a read-only memory (ROM) 1403, and a hard disk (HD) 1404. For example, a hard disk may be used as the HD 1404. The computer includes the CPU 1401 that executes a program implementing the communication setup detection module 122, the measurement data recording module 124, the state analysis processing module 144, the physical layout matching module 146, the ID matching module 148, the correction module 150, the output module 152, and the like; the RAM 1402 that stores the program and data; the ROM 1403 that stores a program for booting the computer, and any other suitable item; the HD 1404 that serves as an auxiliary storage device; a receiving device 1406 that receives data in accordance with an operation of a user through a keyboard, a mouse, a touch panel, or any other suitable tool; an output device 1405 such as a cathode-ray tube (CRT) or a liquid crystal display; a communication line interface 1407 for establishing a connection with a communication network, such as a network interface card; and a bus 1408 through which the above components are connected to one another to exchange data. Multiple computers each having the above configuration may be connected to one another via a network.

In the foregoing exemplary embodiment, elements based on a computer program may be implemented by causing a system having the above hardware configuration to read the computer program, or software, and software and hardware resources cooperate with each other, thereby achieving the foregoing exemplary embodiment.

The hardware configuration illustrated in FIG. 14 is merely an example configuration, and this exemplary embodiment is not limited to the configuration illustrated in FIG. 14 so long as to be capable of executing the modules described in the exemplary embodiment. For example, some modules may be configured using dedicated hardware (such as an application specific IC (ASIC)), and other modules may be provided in an external system and may be connected via a communication line. Alternatively, multiple systems each having the configuration illustrated in FIG. 14 may be connected to one another via a communication line and may operate in association with one another. Furthermore, the system illustrated in FIG. 14 may be incorporated in, in particular, a personal computer, a home information appliance, a copying machine, a facsimile machine, a scanner, a printer, a multifunctional device (an image processing apparatus having at least two of functions of devices such as scanner, printer, copier, and facsimile functions), or the like.

Processes in the foregoing exemplary embodiment may be used in combination, and any suitable technique of the related art may be used as a process to be performed by each module.

In the foregoing exemplary embodiment, the phrases “greater than or equal to”, “less than or equal to”, “greater than”, and “smaller than (or less than)” a predetermined value or equivalent phrases may be read as “greater than”, “smaller than (or less than)”, “greater than or equal to”, and “less than or equal to” a predetermined value, respectively, as long as consistency is maintained in the respective combinations.

A program described herein may be provided in the form of being stored in a recording medium, or may be provided via a communication medium. In this case, for example, a computer readable medium storing the program described above may constitute an exemplary embodiment of the present invention.

The computer readable recording medium may be a computer readable recording medium storing a program, which is used for installation, execution, distribution, or the like of the program.

Examples of the recording medium include digital versatile discs (DVDs) including discs complying with a DVD Forum standard, such as DVD-Recordable (DVD-R), DVD-Rewritable (DVD-RW), and DVD-RAM discs, and discs complying with a format supported by the DVD+RW Alliance, such as DVD+R and DVD+RW discs, compact discs (CDs) including compact disc read-only memory (CD-ROM), CD-Recordable (CD-R), and CD-Rewritable (CD-RW) discs, a Blu-ray Disc (registered trademark), a magneto-optical (MO) disk, a flexible disk (FD), a magnetic tape, a hard disk, a ROM, an electrically erasable programmable read-only memory (EEPROM), a flash memory, a RAM, and a Secure Digital (SD) memory card.

The above program or a portion thereof may be recorded in any of the above recording media for saving, distribution, or the like, or may be transmitted via communication using a transmission medium such as a wired network or a wireless communication network, which is used for a local area network (LAN), a metropolitan area network (MAN), a wide area network (WAN), the Internet, an intranet, an extranet, and the like, or a combination thereof, or carried on a carrier.

Furthermore, the program described above may be part of another program, or may be recorded on a recording medium together with a different program. The program may also be recorded separately on plural recording media. The program may also be recorded in any form being capable of restored such as compressed or encoded.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an analysis unit that analyzes an action history of a first subject, in accordance with action information obtained by detecting an action of the first subject;
a starting point determination unit that determines a position of a starting point of an action of the first subject, in accordance with the action history analyzed by the analysis unit, the position of the starting point being represented as a relative coordinate position; and
a coordinate conversion unit that, when a second subject different from the first subject has an absolute coordinate position, converts the relative coordinate position representing the starting point of the action of the first subject into an absolute coordinate position, in accordance with the absolute coordinate position of the second subject.

2. The information processing apparatus according to claim 1, wherein
the action information includes communication information indicating that devices owned by subjects including the first subject have communicated with each other,
the analysis unit extracts a combination of subjects that have communicated with each other, the subjects including the first subject, in accordance with the communication information included in the action information, and
the coordinate conversion unit changes the relative coordinate position representing the starting point of the action of the first subject to an absolute coordinate position, using the absolute coordinate position of the second subject in accordance with the combination of subjects extracted by the analysis unit, the absolute coordinate position being a position of a starting point of an action of the second subject.

3. The information processing apparatus according to claim 1, wherein
the action information includes direction information indicating a direction of the first subject and position information indicating a position of the first subject,
the analysis unit extracts a combination of subjects that have communicated with each other, the subjects including the first subject, or a combination of subjects that are getting together, the subjects including the first subject, in accordance with the direction information and position information which are included in the action information, and
the coordinate conversion unit changes the relative coordinate position representing the starting point of the action of the first subject to an absolute coordinate position, using the absolute coordinate position of the second subject in accordance with the combination of subjects extracted by the analysis unit, the absolute coordinate position being a position of a starting point of an action of the second subject.

4. The information processing apparatus according to claim 2, wherein
the action information includes direction information indicating a direction of the first subject and position information indicating a position of the first subject,
the analysis unit extracts a combination of subjects that have communicated with each other, the subjects including the first subject, or a combination of subjects that are getting together, the subjects including the first subject, in accordance with the direction information and position information which are included in the action information, and
the coordinate conversion unit changes the relative coordinate position representing the starting point of the action of the first subject to an absolute coordinate position, using the absolute coordinate position of the second subject in accordance with the combination of subjects extracted by the analysis unit, the absolute coordinate position being a position of a starting point of an action of the second subject.

5. The information processing apparatus according to claim 3, wherein
the analysis unit extracts a combination of subjects including the first subject, in accordance with relationship information indicating a relationship between subjects including the first subject.

6. The information processing apparatus according to claim 4, wherein
the analysis unit extracts a combination of subjects including the first subject, in accordance with relationship information indicating a relationship between subjects including the first subject.

7. The information processing apparatus according to claim 1, further comprising:
a map generation unit that generates a map including the starting point and a path along which the first subject has moved, the starting point being a point at which a desk is located, the path being an aisle.

8. An information processing method comprising:
analyzing an action history of a first subject, in accordance with action information obtained by detecting an action of the first subject;
determining that determines a position of a starting point of an action of the first subject, in accordance with the analyzed action history, the position of the starting point being represented as a relative coordinate position; and
when a second subject different from the first subject has an absolute coordinate position, converting the relative coordinate position representing the starting point of the action of the first subject into an absolute coordinate position, in accordance with the absolute coordinate position of the second subject.

9. A computer readable medium storing a program causing a computer to execute a process for performing information processing, the process comprising:
analyzing an action history of a first subject, in accordance with action information obtained by detecting an action of the first subject;
determining that determines a position of a starting point of an action of the first subject, in accordance with the analyzed action history, the position of the starting point being represented as a relative coordinate position; and
when a second subject different from the first subject has an absolute coordinate position, converting the relative coordinate position representing the starting point of the action of the first subject into an absolute coordinate position, in accordance with the absolute coordinate position of the second subject.
